(19) United States
(12) Patent Application Publication
(10) Pub. No.: US 2015/0073969 A1
(43) Pub. Date: Mar. 12, 2015

(54) TRANSCATIONALLY BASED BENCHMARK FOR MARKET TRANSACTIONS IN SHORT TERM SECURITIES

(71) Applicant: The Depository Trust & Clearing Corporation, New York, NY (US)

(72) Inventor: John V. Kiechle, Patterson, NY (US)

(21) Appl. No.: 14/478,050

(22) Filed: Sep. 5, 2014

Related U.S. Application Data
(60) Provisional application No. 61/874,594, filed on Sep. 6, 2013.

(51) Int. Cl. G06Q 40/04

(52) U.S. Cl. CPC G06Q 40/04
USPC 705/37

(57) ABSTRACT

The present invention provides systems, methods, apparatus, and computer program products related to calculating and distributing objective benchmarks configured to provide insight to various portions of the securities market. In various embodiments, a method for providing a short term security intraday benchmark is provided. The method may comprise collecting transactional data for a short term security. The transactional data may be parsed from transactions associated with the short term security within a predetermined time period. The method may further comprise calculating a benchmark based at least in part on the transactional data and execution of a predetermined algorithm; and providing the benchmark in a digital format.

### CROSS-REFERENCE TO RELATED APPLICATIONS

This application claims priority to U.S. Application No. 61/874,594, filed Sep. 6, 2013, which is incorporated by reference herein.

### BACKGROUND

Short term securities (e.g., Commercial Paper, Institutional Certificates of Deposit, and other Money Market Instruments) make up an important part of the financial market. However, short term security markets are known to have highly variable interest rates that may depend on various attributes of the issuer and/or dealer. Additionally, in various short term security markets, up to thousands of transactions may occur daily, making it difficult for issuers, dealers, and/or market participants to compare a particular interest rate against interest rates from contemporaneous transactions.

Therefore, there exists a need for a benchmark, or suite of benchmarks, based on data collected from actual market transactions and provided on a real-time, near real-time, on an intra-day, and/or daily basis. Further there is a need for methods, systems, apparatus, and computer program products for calculating and distributing such a benchmark to market participants and other users.

### BRIEF SUMMARY

The present invention provides for an objective benchmark or suite of benchmarks that are relevant to the Commercial Paper (CP) market, Institutional Certificate of Deposit (CD) market, Money Market Instrument (MMI) and/or other markets. In various embodiments, the benchmark and/or suite of benchmarks may be configured to comply with applicable regulatory standards regarding benchmarks (e.g., Principles of Financial Benchmarks published by the International Organization of Securities Commissions and/or the like). In various embodiments, the benchmark or suite of benchmarks may be provided and/or distributed to one or more users on a real-time, near real-time, intra-day, and/or end-of-day basis. Thus, the present invention will provide entities with an opportunity to compare their rates with a real-time, near real-time, intra-day, and/or end-of-day industry weighted average. In various embodiments, a user may personalize the distribution of the benchmark or suite of benchmarks. For example, in some embodiments, a user may choose how often and/or when they receive the benchmark or suite of benchmarks, which benchmarks in the suite of benchmarks they receive, and/or the format in which they receive the benchmark or suite of benchmarks. As the benchmark or suite of benchmarks is based on data collected from transactions, the present invention provides greater transparency for all market participants who trade in the CP/CD/MMI market. Additionally, various embodiments of the present invention provide methods, systems, apparatus, and computer program products for calculating and distributing the provided benchmark or suites of benchmarks to one or more users.

According to one aspect of the present invention, a method for providing a short term security intraday benchmark is provided. In various embodiments, the method may comprise collecting transactional data for a short term security. The transactional data may be parsed from transactions associated with the short term security within a predetermined time period (e.g., via one or more processors). The method may further comprise calculating a benchmark based at least in part on the transactional data and execution of a predetermined algorithm; and providing, via the one or more processors, the benchmark in a digital format.

According to another aspect of the present invention, a system for providing a short term security intraday benchmark is provided. In various embodiments, the system may comprise at least one memory and at least one processor. The at least one memory may be configured to store transactional data for a short term security. The at least one processor may be configured to collect the transactional data for the short term security. The transactional data may be parsed from transactions associated with the short term security within a predetermined time period. The at least one processor may be further configured to calculate a benchmark based at least in part on the transactional data and a predetermined algorithm; and provide the benchmark in a digital format.

In yet another aspect of the present invention, a computer program product for providing a short term security intraday benchmark is provided. In various embodiments, the computer program product may comprise at least one non-transitory computer-readable storage medium having computer-readable program code portions stored therein. The computer-readable program code portions may comprise an executable portion configured to collect the transactional data for the short term security. The transactional data is parsed from transactions associated with the short term security within a predetermined time period. The computer-readable program code portions may further comprise an executable portion configured to calculate a benchmark based at least in part on the transactional data and a predetermined algorithm; and an executable portion configured to provide the benchmark in a digital format.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of a system for processing and handling a package associated with a delivery exception, in accordance with the present invention

FIG. 2 is a schematic diagram of a market transaction system, in accordance with various embodiments of the present invention;

FIG. 3 is a flowchart illustrating an process for providing an objective benchmark or suite of benchmarks, in accordance with various embodiments of the present invention; and

FIGS. 4A-4G show example screen shots of the format in which example suites of benchmarks may be distributed, in accordance with various embodiments of the present invention.

### DETAILED DESCRIPTION OF VARIOUS EMBODIMENTS

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### Methods, Apparatus, Systems, and Computer Program Products

As should be appreciated, the embodiments may be implemented as methods, apparatus, systems, or computer program products. Accordingly, the embodiments may take the form of an entirely hardware embodiment, an entirely software embodiment, or an embodiment combining software and hardware aspects. Furthermore, the various implementations may take the form of a computer program product on a computer-readable storage medium having computer-readable program instructions (e.g., computer software) embodied in the storage medium. More particularly, implementations of the embodiments may take the form of web-implemented computer software. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, can be implemented by computer program instructions, e.g., as logical steps or operations. These computer program instructions may be loaded onto a general purpose computer, special purpose computer, or other programmable data processing apparatus to produce a machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

In general, the terms computing entity, entity, device, system, and/or similar words used herein interchangeably may refer to, for example, one or more computers, computing entities, computing devices, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

### Glossary

The terms below are defined for the purposes of describing the invention herein only and are not intended to, and do not in any way, supersede any meaning that may be ascribed to them under the Rules & Procedures of DTC (available at www.dtcc.com).

Issuer—An issuer is the organization, company, institution, bank, entity, or the like that issues a security (e.g., Commercial Paper, Institutional Certificate of Deposit, Money Market Instrument, and/or the like).

Dealer—A dealer is an organization, company, institution, bank, entity, or the like that buys securities from an issuer and then sells the securities and/or shares in the securities to market participants. In some cases, the issuer may sell the securities to market participants, bypassing the dealer.

Market Participants—A market participant is an organization, company, institution, bank, entity, individual, or the like that invests in at least one security.

User—A user may be an issuer, dealer, market participant, and/or other individual, organization, company, institution, entity, and/or the like. Particularly, a user chooses to access or has requested access to the benchmark.

Commercial Paper (CP)—A commercial paper (CP) is a form of short-term, unsecured debt with a fixed maturity of no more than 270 days.

Institutional Certificate of Deposit (CD)—An institutional certificate of deposit (CD) is a certificate of deposit with a minimum size of $100,000.

Money Market Instrument (MMI)—A short-term security that matures in less than a year (e.g., treasury bills, bankers' acceptance, municipal bonds, and/or the like).

AA—A credit rating assigned by a rating agency to an issuer indicating that securities issued by the dealer are high quality, low-risk securities.

A2/P2—A credit rating assigned by a rating agency to an issuer indicating that the dealer has a strong ability to repay short-term debt obligations.

### General Overview

The present invention provides a benchmark and/or a suite of benchmarks that is calculated based on transactional data and therefore is both objective and offers insight into the market. Herein, for the sake of simplicity, the term “benchmark” will be used to refer to both a single benchmark and/or a suite of benchmarks, unless otherwise stated. In various embodiments, a benchmark may comprise a range of interest rates, an average interest rate, a weighted average, aggregate interest rate, a volume statistic, and/or the like. Various algorithms may be used to calculate a given benchmark. For example, the algorithm may be configured to calculate an average index weighted by dollar value volume, number of issues volume, issuer credit rating, length of time until maturity, and/or the like. In various embodiments, a benchmark may be calculated via a trimmed or truncated mean algorithm.

In various embodiments of the present invention, a blended benchmark is provided. For example, in some embodiments, a blended benchmark may comprise information related to CPs and CDs, CPs and MMIs (e.g., municipal bonds), or CPs, CDs, and MMIs. Thus, a blended benchmark may be used to offer insight into a variety of markets. In various embodiments, an algorithm may be used to combine benchmarks related to various markets. For example, in one embodiment, a CP benchmark may be calculated via the CP benchmark algorithm and a CD benchmark may be calculated via the CD benchmark algorithm. A blended CP/CD algorithm may then be used to calculate a blended CP/CD algorithm based on the individual CD and CP benchmarks. In other embodiments, a blended benchmark algorithm may use the raw transactional data for one or more markets to calculate a blended benchmark.

The present invention further provides methods, systems, apparatus, and computer program products for calculating and distributing the provided benchmark. For example, in various embodiments, the present invention may provide a system configured to gather data, process the data, and calculate the benchmark. In one embodiment, the present invention may provide a system configured to present the benchmark in an electronic format that may be published on a website, emailed to a user, and/or downloaded via an application (i.e., “app”) on a mobile device. An example system architecture that may be used in accordance with various embodiments of the present invention will now be discussed.

### System Architecture

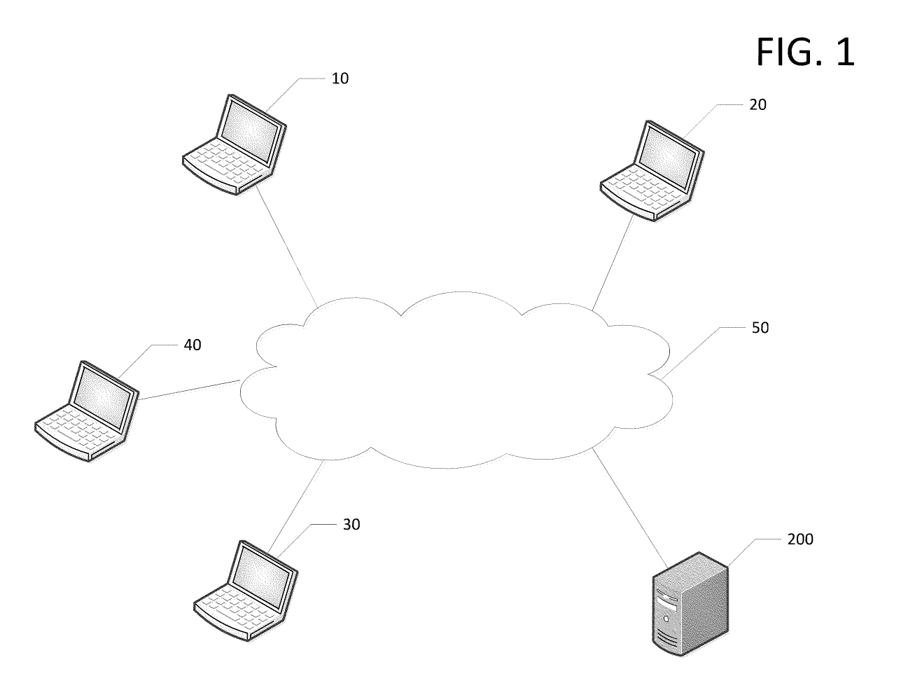

FIG. 1 illustrates one example embodiment of a system that may implement the present invention. The illustrated system includes one or more issuer computing devices 10, one or more dealer computing devices 20, one or more market participant computing devices 30, one or more user computing devices 40, and one or more market transaction systems 200. The one or more issuer computing devices 10, one or more dealer computing devices 20, one or more market participant computing devices 30, one or more user computing devices 40, and one or more market transaction systems 200 may communicate via one or more wired or wireless networks 50.

In various embodiments, the market transaction system 200 may process transactions between an issuer and a dealer, an issuer and one or more market participants, and/or a dealer and one or more market participants. Thus, the market transaction system 200 may be in communication with one or more issuer computing devices 10, one or more dealer computing devices 20, and/or one or more market participant computing devices 30. In various embodiments, the market transaction system 200 may act as a clearinghouse for transactions between issuers, dealers, and/or market participants. During the processing of various transactions, the market transaction system 200 may collect a variety of data categorizing the issuer and/or dealer, interest rate, and/or other information associated with various transactions. In various embodiments, the market transaction system 200 may process the collected data and calculate the benchmark. The market transaction system 200 may then distribute the benchmark. For example, the market transaction system 200 may transmit the benchmark to the user computing device 40 or otherwise make the benchmark available to the user computing device 40. Thus, the market transaction system 200 may also be in communication with one or more user computing devices 40.

### Market Transaction System 200

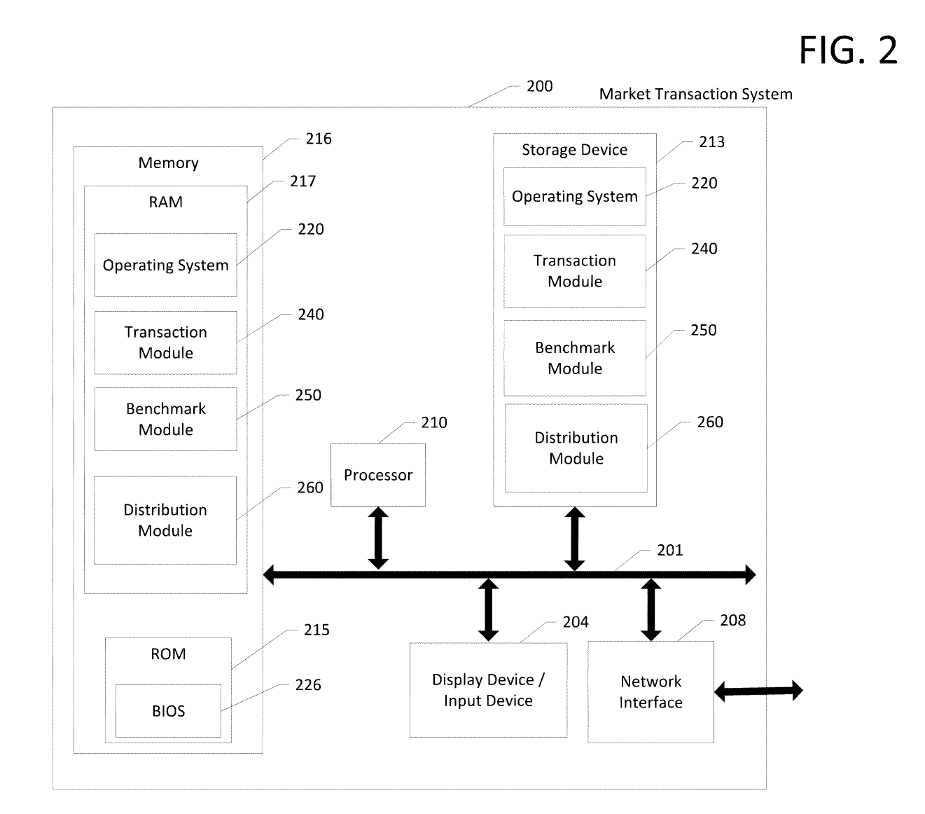

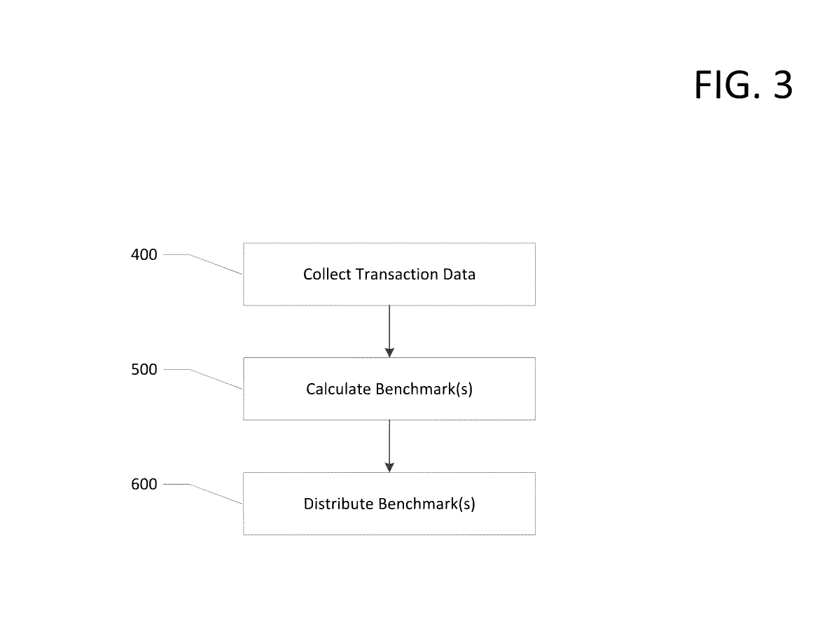

FIG. 2 provides a schematic diagram of a market transaction system 200. The market transaction system 200 comprises a processor 210, such as one or more processing elements, which may include complex programmable logic devices (CPLDs), microprocessors, multi-core processors, coprocessing entities, application-specific instruction-set processors (ASIPs), and/or controllers or other processing devices or circuitry. The term circuitry may refer to an entirely hardware embodiment or a combination of hardware and computer program products. Thus, the processor 210 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processor 210 may be configured for a particular use or configured to execute instructions stored in volatile or non-volatile media or otherwise accessible to the processor 210. As such, whether configured by hardware or computer program products, or by a combination thereof, the processor 210 may be capable of performing steps or operations according to embodiments of the present invention, such as the embodiment illustrated in FIG. 3, when configured accordingly. The processor 210 is used to execute software instructions for carrying out the defined steps of the method of the various embodiments of the present invention. The processor 210 communicates using a data bus 201 that is used to convey data and program instructions, typically, between the processor and memory 216.

The market transaction system 200 further includes memory 216, which may comprise non-volatile media (also referred to as non-volatile storage, memory, memory storage, memory circuitry and/or similar terms used herein interchangeably). In one embodiment, the non-volatile storage or memory may include one or more non-volatile storage or memory media as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. In various embodiments, memory 216 includes both read only memory (ROM) 215 and random access memory (RAM) 217. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include the transaction module 240, the benchmark module 250, and/or the distribution module 260. The term database, database instance, database management system, and/or similar terms used herein interchangeably may refer to a structured collection of records or data that is stored in a computer-readable storage medium, such as via a relational database, hierarchical database, and/or network database.

In at least one embodiment, the market transaction system 200 may further include or be in communication with volatile media (also referred to as volatile storage, memory, memory storage, memory circuitry and/or similar terms used herein interchangeably). In one embodiment, the volatile storage or memory may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processor 210. Thus, the databases, database instances, database management systems, data, applications, programs, program modules, scripts, source code, object code, byte code, compiled code, interpreted code, machine code, executable instructions, and/or the like may be used to control certain aspects of the operation of the market transaction system 200 with the assistance of the processor 210 and operating system 220, such as the transaction module 240, the benchmark module 250 and/or the distribution module 260.

In various embodiments, memory 216 can be considered primary memory such as RAM memory or other forms which retain the contents only during operation, or it may be a non-volatile memory, such as ROM, EPROM, EEPROM, FLASH, or other types of memory that retain the memory contents. In some embodiments, the disk storage may communicate with the processor 210 using an I/O bus instead of a dedicated bus 201. The memory 216 could also be secondary memory, such as disk storage, that stores a relatively large amount of data. The secondary memory may be a floppy disk, hard disk, compact disk, DVD, or any other type of mass storage type known to those skilled in the computer arts. The memory may also comprise any application program interface, system, libraries and any other data by the processor to carry out its functions. ROM 215 is used to store a basic input/output system 226 (BIOS), containing the basic routines that help to transfer information between components of the market transaction system 200, including the transaction module 240, the benchmark module 250, the distribution module 260, and/or the operating system 220.

In addition, the market transaction system 200 includes at least one storage device 213, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 213 is connected to the system bus 201 by an appropriate interface. It is important to note that the computer-readable media described above could be replaced by any other type of computer-readable media known in the art. Such media include, for example, memory sticks (e.g., USB memories), magnetic cassettes, flash memory cards, digital video disks, and Bernoulli cartridges.

A number of program modules may be stored by the various storage devices and within RAM 217. Such program modules include the operating system 220, the transaction module 240, the benchmark module 250 and/or the distribution module 260. Those skilled in the art will appreciate that other modules may be present in RAM 217 to effectuate the various embodiments of the present invention. Furthermore, rather than program modules, the transaction module 240, the benchmark module 250 and/or the distribution module 260 may comprise stand-alone computers connectively coupled to the market transaction system 200.

Also located within the market transaction system 200 is a network interface 208, for interfacing and communicating with other elements of a computer network, such as by communicating data, content, information, and/or similar terms used herein interchangeably that can be transmitted, received, operated on, processed, displayed, stored, and/or the like. For instance, the market transaction system 200 may be in communication with one or more issuer computing devices 10, one or more dealer computing devices 20, one or more market participant computing devices 30, and/or one or more user computing devices 40. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the market transaction system 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Various information is input by a user to the market transaction system 200 via the network interface 208 and/or input/output device 204. This input information may include information related to transactions to be processed, benchmark calculation information, user benchmark distribution preferences, or other information. This input information may vary, however, depending on the configuration and informational requirements of the market transaction system 200.

As mentioned above, the market transaction system 200 also includes an input/output device 204 for receiving and displaying data. The market transaction system 200 may include or be in communication with one or more input elements, such as a keyboard input, a mouse input, a touch screen/display input, audio input, pointing device input, joystick input, keypad input, and/or the like, as indicated by input/output device 204. The market transaction system 200 may also include or be in communication with one or more output elements, as indicated by input/output device 204, such as audio output, video output, screen/display output, motion output, movement output, and/or the like.

The market transaction system 200 is configured to process various market transactions, such as CP transactions, CD transactions, MMI transactions and other market transactions. The market transaction system 200 may further be configured to collect transaction data from the various market transactions processed, such as information related to the issuer and/or dealer, maturity date, and/or interest rate. In various embodiments, the market transaction system 200 may be configured to calculate a benchmark based at least in part on the collected transaction data. The market transaction system 200 may then transmit benchmark information to at least one user based on distribution preferences associated with the user. In various embodiments, the market transaction system 200 may publish benchmark information to a website or other publication medium.

Those skilled in the art will recognize that many other alternatives and architectures are possible and can be used to practice various embodiments of the invention. The embodiment illustrated in FIG. 2 can be modified in different ways or incorporated within a network and be within the scope of the invention. For example, one or more components of the market transaction system 200 may be located remotely from other market transaction system 200 components, such as in a distributed system. Furthermore, one or more of the components may be combined and additional components performing functions described herein may be included in the market transaction system 200. Thus, the market transaction system 200 can be adapted to accommodate a variety of needs and circumstances.

### Issuer Computing Device 10

In various embodiments, an issuer computing device 10 is any computing device operated by or on behalf of an issuer. In one embodiment, the issuer computing device 10 may include one or more components that are functionally similar to those of the market transaction system 200. For example, in one embodiment, the issuer computing device 10 may include one or more processing elements, one or more display device/input devices, volatile and non-volatile storage or memory, and/or one or more communications interfaces. The issuer computing device 10 may also comprise various other systems. In particular, the issuer computing device 10 may include components configured to issue one or more securities, and/or the like. Issuer computing device 10 may be in communication with one or more dealer computing devices 20, one or more market participant devices 30, market transaction system 200, and/or other computing devices.

### Dealer Computing Device 20

In various embodiments, a dealer computing device 20 is any computing device operated by or on behalf of a dealer. In one embodiment, the dealer computing device 20 may include one or more components that are functionally similar to those of the market transaction system 200. For example, in one embodiment, the dealer computing device 20 may include one or more processing elements, one or more display device/input devices, volatile and non-volatile storage or memory, and/or one or more communications interfaces. The dealer computing device 20 may also comprise various other systems. In particular, the dealer computing device 20 may include components configured to buy one or more securities, sell one or more in the securities market, and/or the like. Dealer computing device 20 may be in communication with one or more issuer computing devices 10, one or more market participant devices 30, market transaction system 200, and/or other computing devices.

### Market Participant Computing Device 30

In various embodiments, a market participant computing device 30 is any computing device operated by or on behalf of a market participant. In one embodiment, the market participant computing device 30 may include one or more components that are functionally similar to those of the market transaction system 200. For example, in one embodiment, the market participant computing device 30 may include one or more processing elements, one or more display device/input devices, volatile and non-volatile storage or memory, and/or one or more communications interfaces. The market participant computing device 30 may also comprise various other systems. In particular, the market participant computing device 30 may include components configured to buy one or more securities in the market, and/or the like. Market participant computing device 30 may be in communication with one or more issuer computing devices 10, one or more dealer devices 20, market transaction system 200, and/or other computing devices.

### User Computing Device 40

In various embodiments, a user computing device 40 is any computing device operated by a user interested in viewing, downloading, and/or otherwise accessing the benchmark. In various embodiments, a user computing device 40 may also be a dealer computing device 10, an issuer computing device 20, and/or a market participant computing device 30. In one embodiment, the user computing device 40 may include one or more components that are functionally similar to those of the market transaction system 200. For example, in one embodiment, the user computing device 40 may include one or more processing elements, one or more display device/input devices, volatile and non-volatile storage or memory, and/or one or more communications interfaces. In various embodiments, the user computing device 40 may be a handheld computing device such as a smartphone, PDA, tablet, netbook, laptop, or the like. In other embodiments, the user computing device may be a desktop computer, server, terminal in communication with a server, or the like. The user computing device 40 may also comprise various other systems. In particular, the user computing device 40 may include components configured to download or otherwise access the benchmark and/or display the benchmark to a user. The user computing device 40 may be in communication with one market transaction system 200 and/or other computing devices.

### System Operation

As indicated above, various embodiments of the market transaction system 200 may operate various modules (e.g., modules 240, 250, and/or 260). In various embodiments, the transaction module 240 is configured to process a variety of market transactions. Particularly, the transaction module 240 is configured to collect data related to the processed market transactions. In various embodiments, the benchmark module 250 is configured to process data collected by the transaction module 240. The benchmark module 250 may be further configured to calculate the benchmark. In various embodiments, the distribution module 260 is configured to distribute the benchmark. In various embodiments, the distribution module 260 may be configured to publish the benchmark to a website, transmit the benchmark to an electronic address associated with at least one user, provide a downloadable version of the benchmark via a website or ftp server, and/or otherwise distribute the benchmark. As should be appreciated, various embodiments may combine the functionality of the modules 240, 250, and/or 260 or may substitute one or more modules 240, 250, and/or 260 for other methods to incorporate the functionality described herein with respect to the modules 240, 250, and 260.

The functions of modules 240, 250 and 260 shall now be described with reference to FIG. 3.

### Transaction Module 240

The transaction module 240 is configured to mediate and/or process a variety of security transactions. For example, the transaction module 240 may process a security transaction wherein an issuer or dealer offers for sale a CP, possibly via issuer computing device 10 or a dealer computing device 20, and a market participant, possibly via market participant computing device 30, purchases the CP. The transaction module 240 may act as a clearinghouse to credit an account associated with the issuer or dealer an amount based on the purchase price of the CP and debit an account associated with the market participant an amount based on the purchase price of the CP.

In various embodiments, the transaction module 240 is configured to complete step 400 by collecting data from each mediated and/or processed transaction. For example, the transaction module 240 may collect data related to the interest rate of a transaction, the dollar value of the transaction, whether the transaction was discounted, information related to the maturation of the transaction, information related to the dealer and/or issuer of the transaction (e.g., whether the dealer is a financial or non-financial corporation, the credit rating of the dealer, and/or the like), information related to the market participant, and/or the like. In various embodiments, the transaction module 240 may collect any of a variety of data related to the transaction and/or the transaction participants. The collected data may be stored in a database or other storage medium and/or used by benchmark module 250 to calculate the benchmark. For example, in various embodiments, the transaction module 240 may parse the transactions to populate a transaction database with various information/data related to each transaction as the transaction is being processed. For example, the transaction data may be parsed from the transaction as the transaction is being passed through the clearinghouse. In another embodiment, the transaction module 240 may parse information from one or more transactions before the transaction is processed or after the processing of the transaction is complete. For example, all of the transactions or a selected group of transactions that were processed in the last 24 hours, 12 hours, 6 hours, and/or other predetermined time period may be parsed at a particular time (e.g., immediately before the benchmark is calculated, and/or the like). Benchmark Module 250

As noted above, the term benchmark is used herein to refer to one or more benchmarks and/or a suite of benchmarks. The benchmark may be configured to provide an entity (e.g., an issuer, a market participant, and/or the like) with an opportunity to compare a particular interest rate with an industry weighted average, thereby allowing the entity to determine whether the particular interest rate is competitive. The benchmark module 250 is configured to calculate the benchmark using the transactional data collected by the transaction module 240. At step 500, the benchmark module 250 may calculate the benchmark via one or more predetermined algorithms. In various embodiments, an algorithm used to calculate a benchmark may include removing the data related to the one or more highest interest rates from the calculation. For example, in some embodiments, the five or ten highest interest rates in the data set may be removed from the calculation. In various embodiments, an algorithm used to calculate a benchmark may include removing the data related to the one or more lowest interest rates from the calculation. For example, in some embodiments, the five or ten lowest interest rates in the data set may be removed from the calculation. In some such embodiments, the algorithm may be used to calculate a truncated or trimmed mean, such as an interquartile mean and/or the like. In various embodiments, an algorithm used to calculate a benchmark may include calculating a weighted average of interest rates in the data set. For example, the average may be weighted based on dollar value volume, number of issues volume, issuer credit rating, length of time until maturity, and/or the like and/or various combinations thereof. In one example, an algorithm may be used to calculate weighted-average aggregate interest rates for CPs and CDs based on the transactional data collected by the transaction module 240. In various embodiments, a benchmark may be calculated via an iterative algorithm configured to iterate a sub-algorithm a fixed number of times or until a specific level of accuracy and/or stability of the solution is achieved.

In various embodiments, the benchmark module 250 may calculate a blended benchmark. For example, a benchmark may be calculated that considers data related to CP transactions and CD transactions. In another embodiment, a benchmark may be calculated that considers data related to CP transactions and MMI transactions, such as municipal bond transactions. In yet another embodiment, a benchmark may be calculated that considers data related to CP transactions, CD transactions, and MMI transactions, such as municipal bonds, general collateral finance repurchase agreements (GCF Repo) index, and/or another type of security transaction. In various embodiments, a blended benchmark algorithm may consider already determined individual market benchmarks. For example, in one embodiment, the input for a CP/CD blended benchmark algorithm may be a CP benchmark and a CD benchmark. In other embodiments, a blended benchmark algorithm may consider the transactional data itself. In various such embodiments, the algorithm may parse the various transactional data into a multi-dimensional array or matrix. For example, a CP/CD blended benchmark algorithm may parse the CP transactional data and the CD transactional data into a two dimensional array or matrix. In another example, a CP/CD/MMI blended benchmark algorithm may parse the CP transactional data, the CD transactional data, and MMI transactional data into a three or more dimensional array or matrix. In one embodiment, a CP/CD blended benchmark may be calculated via an algorithm for calculating a weighted-average aggregate interest rate and/or volume.

In various embodiments, a benchmark is calculated for a particular group of transactions. For example, a benchmark may be calculated for a group of transactions wherein the dealers in the transactions are all of a particular category. For example, a benchmark may be calculated for transactions wherein the dealer is an AA financial corporation, an AA non-financial corporation, an A2/P2 nonfinancial corporation, and/or the like. In other embodiments, a benchmark may be calculated for groups of transactions wherein the groups are based on the maturity date of the transaction. For example, an interest rate benchmark may be calculated for transactions that mature in 1 day, 7 days, 15 days, 30 days, 60 days, 90 days, and/or the like. In another example, a volume benchmark may be calculated for transactions that mature in 1-4 days, 5-9 days, 10-20 days, 21-40 days, 41-80 days, and 81+ days, and/or the like. In some embodiments, a benchmark may be calculated based on groups of transactions wherein the groups of transactions comprise secured and non-secured transactions, domestic and foreign transactions, issuer rating, and/or the like.

In various embodiments, the benchmark may be calculated at various time intervals and/or at various times during the day. For example, the benchmark may be calculated hourly using data collected from all of the relevant transactions that were processed within the last hour or the last two or three hours, and/or other intra-day or end-of-day time frames. In other embodiments, the benchmark may be calculated every other hour using all data from all of the relevant transactions that were processed that day. In other embodiments, the benchmark may be calculated at specific times during the day. For example, the benchmark may be calculated at noon Eastern Standard Time (EST) using data from all of the relevant transactions that were processed that day. In another example, the benchmark may be calculated at 3 pm EST using data from all of the relevant transactions that were processed that day or that were processed since 11 am or noon that day. In various embodiments, the benchmark may be calculated at the end of the day using data from all of the relevant transactions that were processed that day or during various time bands that day.

### Distribution Module 260

In various embodiments, distribution module 260 may be configured to distribute the benchmark, at step 600. In various embodiments, the distribution module 260 may publish the benchmark to a web page, make the benchmark available for download, provide the benchmark via an application or “app” operating on a user computing device 40, or otherwise make the benchmark available to a user, possibly via user computing device 40. In various embodiments, the benchmark may be distributed by the distribution module 260 substantially immediately after the benchmark is calculated by the benchmark module 250, after a short delay after the benchmark is calculated, after the benchmark has received an automated or manual quality control check, and/or at specific times of day. Thus, in some embodiments, the distribution module 260 may provide the benchmark on a real-time, near real-time, intra-day, and/or end-of-day basis. In various embodiments, the distribution module 260 may be configured to provide the benchmark at any of a variety of periodically-timed updates, as may be defined preferences stored in a user profile, as described below.

In various embodiments, the distribution module 260 may further be configured to manage a user profile for at least one user. The user profile may comprise a user name or number. The user profile may further comprise information related to user's benchmark distribution preferences. For example, if a user prefers to receive the benchmark via email, the user's user profile may comprise an email address. If the user wishes to receive a benchmark via text message or some other electronic form of communication, the user's user profile may comprise an electronic destination address. In some embodiments, the distribution preferences stored in a user's user profile may comprise at least one benchmark from a suite of benchmarks that the user would like to receive, times at which the user would like to receive the at least one benchmark, formatting preferences related to how a user would prefer to view the benchmark, and/or other benchmark distribution preferences.

In various embodiments, the distribution module 260 may be configured to distribute the benchmark in accordance with the benchmark distribution preferences stored in at least one user profile. Thus, for example, the distribution module 260 may transmit a voice message to a user specified telephone number at a user-specified time of day wherein the voice message comprises at least one benchmark selected by the user, in accordance with the distribution preferences stored in the user's user profile.

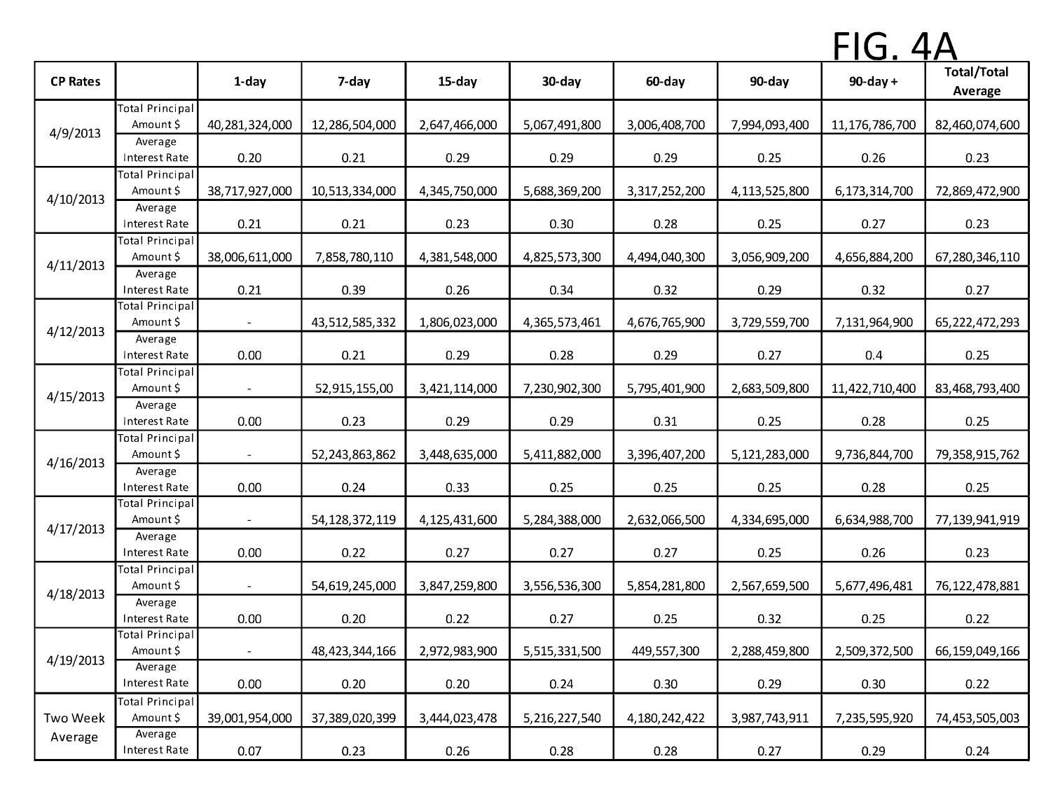

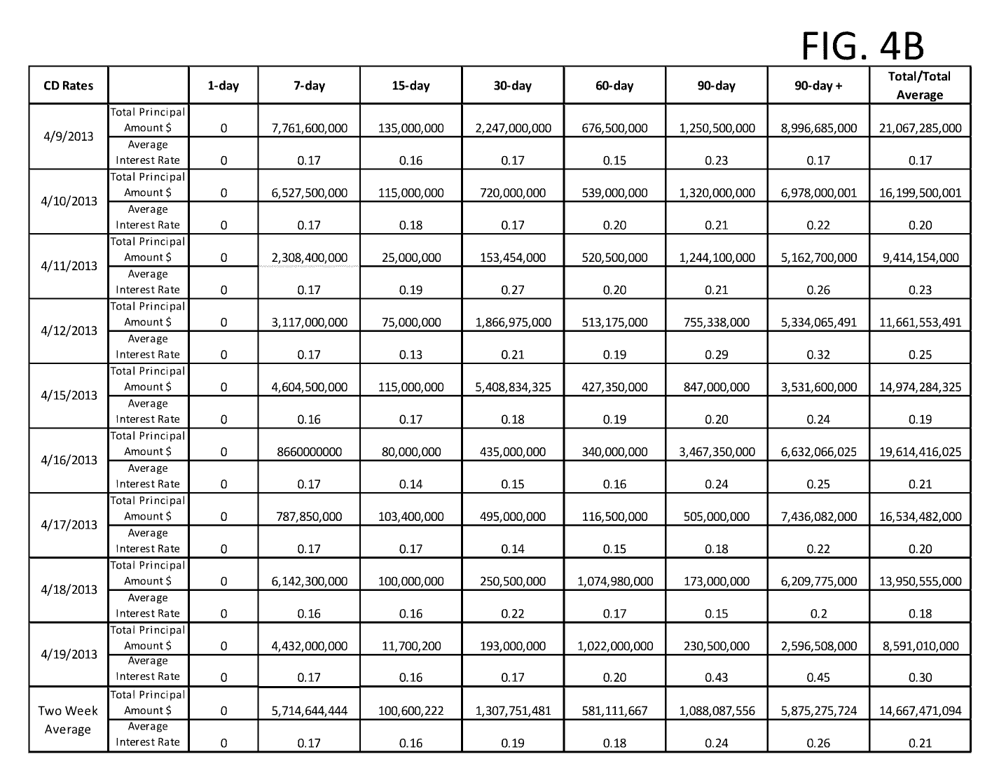

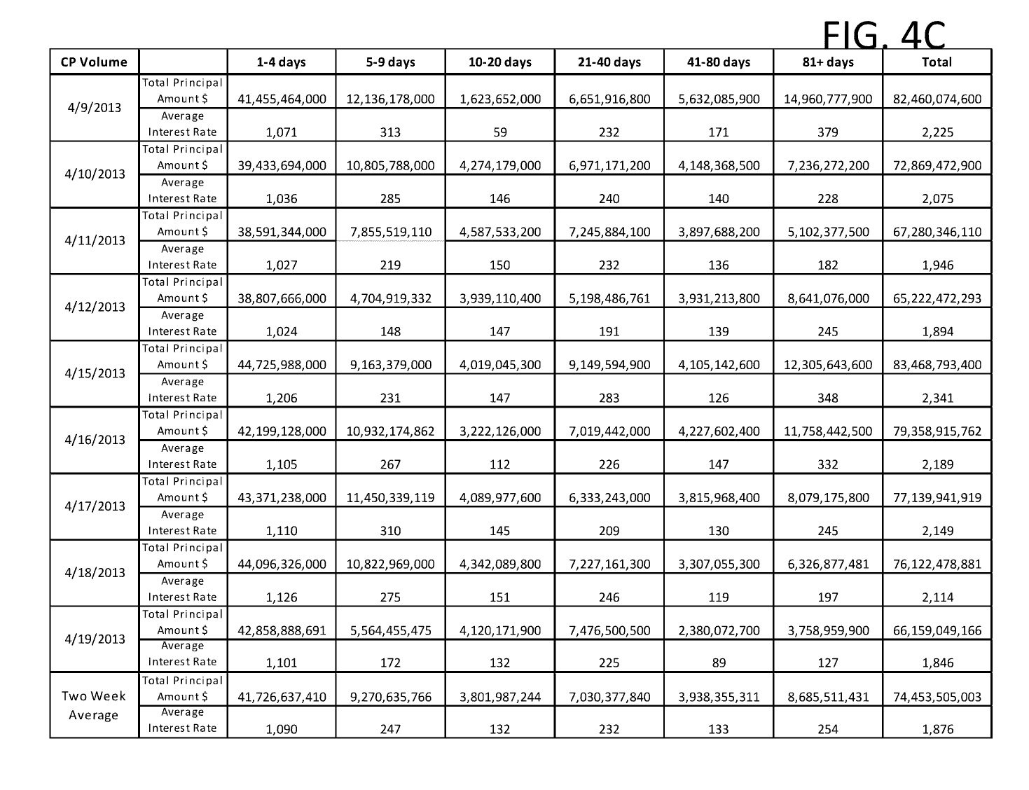

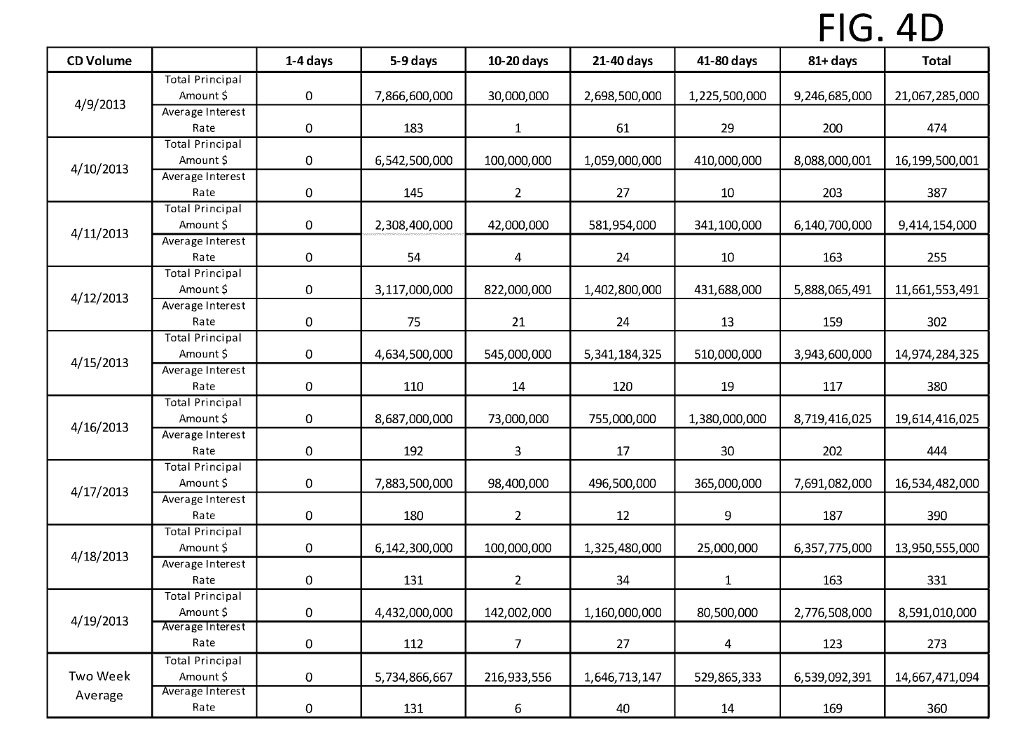

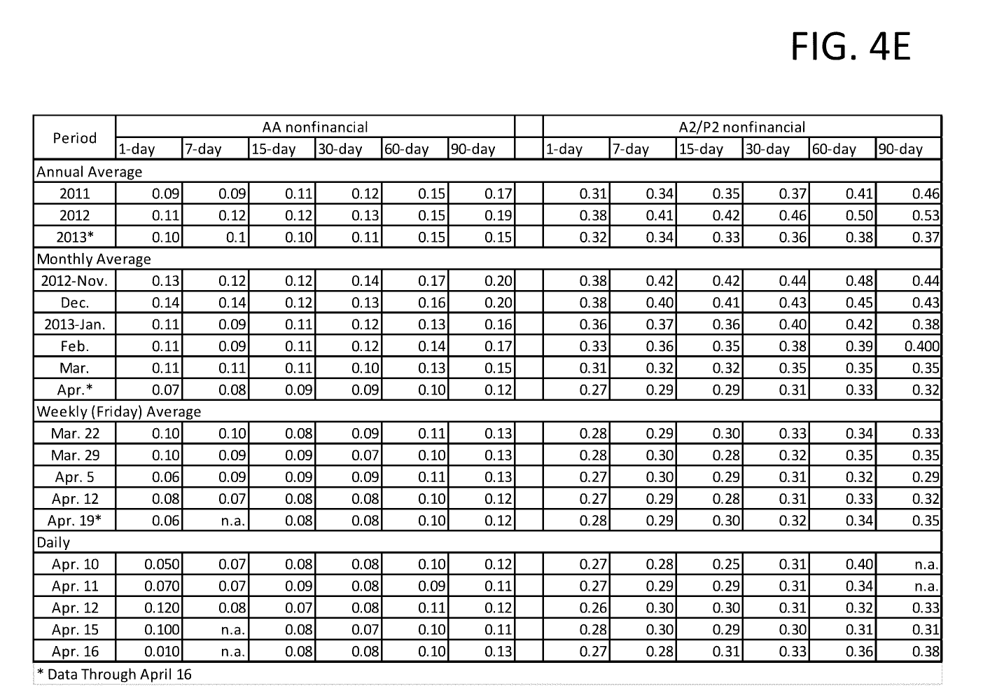

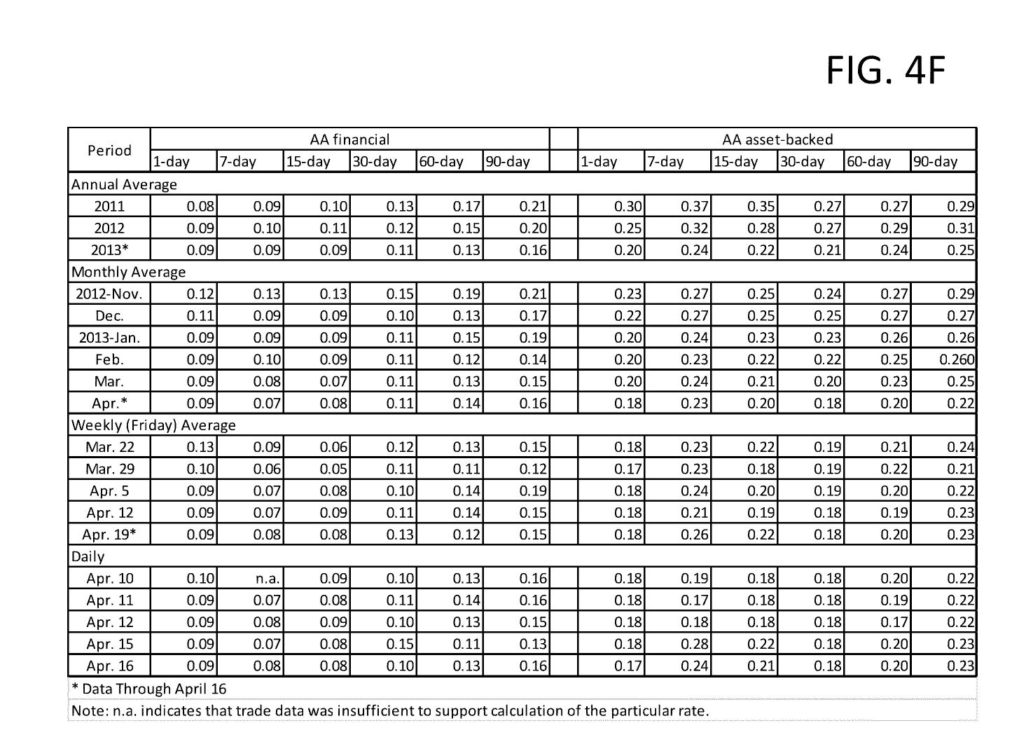

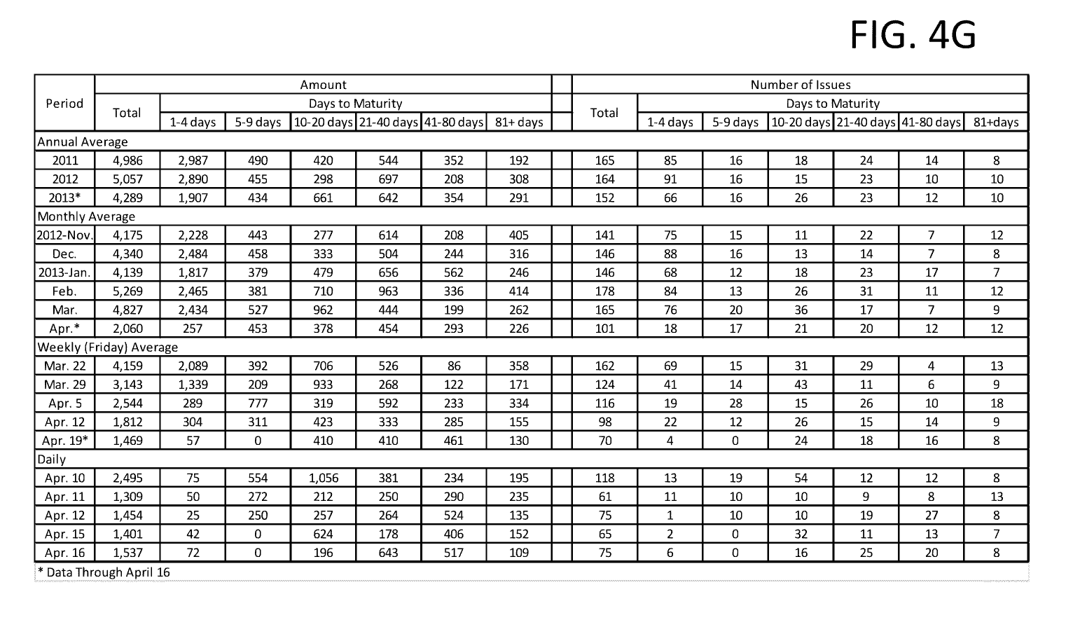

FIGS. 4A-4G show example screen shots of how various suits of benchmarks that may be calculated by the benchmark module 250 and distributed by the distribution module 260 may be published to a website in one embodiment of the present invention. FIG. 4A shows an example screen shot of a web page displaying a daily benchmark for CP transactions processed during the last two weeks. A benchmark is calculated for all of the relevant CP transactions processed that day and for the relevant CP transactions processed that day for each of a set of maturity dates. For each day, a total volume and average interest rate is displayed for all relevant CP transactions processed that day and for each group of CP transactions characterized by maturity band that were processed that day. A two week average volume and interest rate is provided for all of the relevant CP transactions and for each maturity band of relevant CP transactions processed during that two week period.

FIG. 4B shows an example screen shot of a web page displaying a daily benchmark for CD transactions processed during a two week period. A benchmark is calculated for each of a set of maturity bands. For each day, a total volume and average interest rate is displayed for all relevant CD transaction and for each group of relevant CD transactions, characterized by maturity band, processed that day. A two week average volume and interest rate is provided for each group of transactions characterized by maturity band in addition to the two week average volume and interest rate for all of the relevant CD transactions processed during that two week period.

FIGS. 4C and 4D are similar to FIGS. 4A and 4B, but instead show example screen shots of web pages displaying daily volume benchmarks, rather than interest rate benchmarks. FIG. 4C shows daily volume benchmarks for CP transactions over a two week period broken down by maturity date bands and FIG. 4D shows volume benchmarks for CD transactions over a two week period broken down by maturity date bands.

FIGS. 4E and 4F show example screen shots of a suite of benchmarks for CP transactions that may be displayed on a web page in accordance with various embodiments of the present invention. These suites of benchmarks are provided for various groups of transactions such as transactions where the issuer is an AA nonfinancial corporation, where the issuers is an A2/P2 nonfinancial corporation, where the issuer is an AA financial corporation, and when the security is AA asset-backed. FIGS. 4E and 4F show an annual interest rate benchmark for the previous two years and for the current year through mid-April, for all relevant CP transactions broken down by maturity dates for each group of transactions. Also shown is a monthly interest rate benchmark for the five month period spanning November 2012 through March 2013 and a portion of April 2013, for all relevant CP transactions broken down by maturity dates, for each group of transactions. The weekly interest rate benchmark for the last full four weeks of that period and a few additional days, for all relevant CP transactions broken down by maturity dates, for each group of transactions are also shown. Additionally, the daily interest rate benchmarks for CP transactions processed in each of the last five days of that period are shown broken down by maturity dates for each group of transactions are also shown.

FIG. 4G shows an example screen shot of a suite of volume benchmarks for CP transactions wherein the dealer is an AA nonfinancial corporation. The left suite of benchmarks shows the amount of the transactions in billions of US dollars and the right suit of benchmarks shows the number of transactions. Annual volume for the previous two years and the current year through mid-April are shown for all of the relevant CP transactions and broken down by maturity date bands. The monthly volume for the five month period spanning November 2012 through March 2013 and a portion of April 2013 are shown for all of the relevant CP transactions and broken down by maturity date bands. The weekly volume for the last full four weeks of that period and a few additional days are also shown for all relevant CP transactions and broken down by maturity date bands. And finally, the daily volume benchmark for each of the last five days in that period is shown for all relevant CP transactions and broken down by maturity date bands. A variety of other benchmark suites may be calculated and distributed in accordance with the present invention. Additionally, the benchmark and/or benchmark suites may be distributed in a variety of formats in addition to the formats shown and/or described herein.

As described herein, the transaction module 240, the benchmark module 250, and the distribution module 260 are separate modules operating on the market transaction system 200. In various embodiments, the functionality of the modules 240, 250, and/or 260 may be implemented via various methods other than those disclosed herein. For example, in some embodiments, the benchmark module 250 may be responsible for managing at least one user profile, which is described herein with regard to the distribution module 260. In another example, modules 240, 250, and/or 260 may be combined into a single module and/or may operate on a computing system separate from and in communication with the market transaction system 200. Thus, modules 240, 250, and 260 are described as separate modules herein in order to describe various functions of the various embodiments, rather than to be limiting.

### Conclusion

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A computer-implemented method for providing a short term security intraday benchmark comprising:
collecting, via one or more processors, transactional data for a short term security, wherein the transactional data is parsed from transactions associated with the short term security within a predetermined time period;
calculating, via the one or more processors, a benchmark based at least in part on the transactional data and execution of a predetermined algorithm; and
providing, via the one or more processors, the benchmark in a digital format.

2. The method of claim 1 wherein the predetermined algorithm is based at least on one of a daily interest rate, a weekly interest rate, a monthly interest rate, an annual interest rate, a daily volume, a weekly volume, a monthly volume, or an annual volume.

3. The method of claim 1 wherein the transactional data is organized into groups of data based at least in part on maturity date bands and a benchmark is calculated for each maturity date band.

4. The method of claim 1 wherein the transactional data is organized into groups of data based at least in part on a category associated with the dealer and a benchmark is calculated for dealer category.

5. The method of claim 1 wherein the benchmark is distributed in accordance with at least one user distribution preference.

6. The method of claim 1 wherein the benchmarks are distributed in a real-time, near real-time, intra-day or end-of-day interval basis.

7. The method of claim 1 wherein collecting the transactional data comprises extracting data from one or more transactions associated with the short term security during the processing of the transaction.

8. The method of claim 1 wherein the algorithm is based at least in part on transactional data related to two or more short term securities.

9. A system for providing a short term security intraday benchmark comprising:
at least one memory, the at least one memory configured to store transactional data for a short term security;
at least one processor, the at least one processor configured to:
collect the transactional data for the short term security, wherein the transactional data is parsed from transactions associated with the short term security within a predetermined time period;
calculate a benchmark based at least in part on the transactional data and a predetermined algorithm; and
provide the benchmark in a digital format.

10. The system of claim 9 wherein the predetermined algorithm is based at least on one of a daily interest rate, a weekly interest rate, a monthly interest rate, an annual interest rate, a daily volume, a weekly volume, a monthly volume, and an annual volume.

11. The system of claim 9 wherein the transactional data is organized into groups of data based at least in part on maturity date bands and a benchmark is calculated for each maturity date band.

12. The system of claim 9 wherein the transactional data is organized into groups of data based at least in part on a category associated with the dealer and a benchmark is calculated for dealer category.

13. The system of claim 9 wherein the benchmark is distributed in accordance with at least one user distribution preference.

14. The system of claim 9 wherein the benchmarks are distributed in a real-time, near real-time, intra-day or end-of-day interval basis.

15. The system of claim 9 wherein collecting the transactional data comprises extracting data from one or more transactions associated with the short term security during the processing of the transaction.

16. The system of claim 9 wherein the algorithm is based at least in part on transactional data related to two or more short term securities.

17. A computer program product for providing a short term security intraday benchmark, the computer program product comprising at least one non-transitory computer-readable storage medium having computer-readable program code portions stored therein, the computer-readable program code portions comprising:
an executable portion configured to collect the transactional data for the short term security, wherein the transactional data is parsed from transactions associated with the short term security within a predetermined time period;
an executable portion configured to calculate a benchmark based at least in part on the transactional data and a predetermined algorithm; and
an executable portion configured to provide the benchmark in a digital format.

18. The computer program product of claim 17 wherein the predetermined algorithm is based at least on one of a daily interest rate, a weekly interest rate, a monthly interest rate, an annual interest rate, a daily volume, a weekly volume, a monthly volume, and an annual volume.

19. The computer program product of claim 17 wherein the transactional data is organized into groups of data based at least in part on maturity date bands and a benchmark is calculated for each maturity date band.

20. The computer program product of claim 17 wherein the transactional data is organized into groups of data based at least in part on a category associated with the dealer and a benchmark is calculated for dealer category.

21. The computer program product of claim 17 wherein the benchmark is distributed in accordance with at least one user distribution preference.

22. The computer program product of claim 17 wherein the benchmarks are distributed in a real-time, near real-time, intra-day or end-of-day interval basis.

23. The computer program product of claim 17 wherein collecting the transactional data comprises extracting data from one or more transactions associated with the short term security during the processing of the transaction.

24. The computer program product of claim 17 wherein the algorithm is based at least in part on transactional data related to two or more short term securities.
